(19) United States
(12) Patent Application Publication
(10) Pub. No.: US 2004/0193477 A1
(43) Pub. Date: Sep. 30, 2004

(54) Method for business analysis

(76) Inventor: Isaac Barzuza, Petach Tikve (IL)

Correspondence Address: STITES & HARBISON PLLC, 1199 NORTH FAIRFAX STREET, SUITE 900, ALEXANDRIA, VA, 22314, US

(21) Appl. No.: 10/746,279

(22) Filed: Dec. 29, 2003

(30) Foreign Application Priority Data
Dec. 28, 2002 (IL) 153,031

(51) Int. Cl. G06F 17/60

(52) U.S. Cl. 705/10

(57) ABSTRACT

A method of business analysis for determining a plurality of parameters that indicate the performance of a firm selling a product, the method comprising processing data including a price of the product and a marketing oriented cost to sell the product by the firm, for generating the plurality of parameters, the value of which indicates the performance of the firm relating to production and sales of the product, such that at least one of the parameters is complexly dependent on the price and marketing oriented cost, and establishing a leading variable that depends on the price and marketing oriented cost such that if a) any set of changes in the price and marketing oriented cost involved in the analysis maintains the leading variable unchanged, the value of the complexly dependent performance indicating parameter remains unchanged, and b) sets of changes in the price and marketing oriented cost involved in the analysis change the leading variable, the value of the complexly dependent performance indicating parameter, also changes.

### FIELD OF THE INVENTION

The present invention relates to a method for business analysis.

### BACKGROUND OF THE INVENTION

Business analysis is an important tool for a large number of practical purposes. It determines a firm's value and credibility and helps to formulate the firm's strategy. It is also significant for a firm's managers, employee, suppliers, consumers, bankers, owners and investors.

Some of the common applications of business analysis are credit analysis, securities analysis, mergers and acquisitions analysis, debt analysis, dividend analysis, corporate communication strategy analysis and general business analysis. The main source of information required for business analysis is the financial statements of the business. However, a successful analysis requires a good knowledge of the industry and of the firm.

A complete business analysis is often represented as a combination of partial segments. For example, one can find the following separation: business strategy analysis; accounting analysis; financial analysis and prospective analysis. The term “business analysis” referred to herein is meant to encompass both the partial analysis, as well as the complete analysis.

A method of business analysis, or a part of a method, comprises of an input of numeric data from the financial statements and other information concerning the industry and a relevant firm. The method processes the data and generates an “output” that consists of a group of parameters, some relate to the past performance and others to the present and the future, that constitute the outcome of the analysis and indicate the past and predicted performance of the firm, which is referred to herein as “performance indicating parameters”. Some of these parameters represent predictions of the future values of sales, profits and other items from firm's financial reports and some are “ratio parameters” such as ROE (the net income of the firm divided by the shareholders equity) or net profit ratio (the net profit divided by the total income, i.e., revenue of the firm). The knowledge of existing levels of these parameters and their prediction, supplies a satisfactory image of the firm and enables its evaluation.

The values of the performance indicating parameters usually depend on the data supplied. Changes in the data usually entail changes in the values of the performance indicating parameters.

Existing methods, however, suffer from a number of drawbacks. The accuracy and reliability of the predictions are low and improvements, even small ones, necessitate a substantial increase in the amount of data required for the analysis.

One of the reasons for failure of existing business analysis is related to the difficulty to provide a reliable prediction of the development of a firm and the industry. A first reason for this difficulty is the enormous number of parameters that influence the sales of the products. A list of these parameters known as the 4Ps contains up to 50 parameters of the following four categories: price, product, place and promotion. The parameters from the 4Ps list are further discussed in “A MODEL OF CONSUMER LOYALTY AND CONSUMER MOVEMENT AMONG THE FIRMS” attached herebelow as Appendix A, and will be referred to as “marketing oriented parameters” and their costs as appear in the financial reports will be referred to as “marketing oriented costs”. An accurate estimate of future sales of a firm requires the knowledge of the specific influence of a price of a product and each of the marketing oriented costs on the firm's sales. This knowledge, which is specific to each firm (and each industry) requires an extensive research whose cost is often beyond the budget of the business analysis.

Not all performance indicating parameters that depend on the marketing oriented costs require knowledge of specific information related to the firm for prediction. For example, the prediction of the marginal profit (the profit from the sale of an extra product) depends on the price, a portion of the marketing oriented costs and a portion of the production costs (namely, it depends on costs known as costs per product—see Appendix 1) in a way that is common to all firms and equals the price minus the per product costs. Once the price and per product costs are predicted, the calculation of their influence on the marginal profit does not require any specific information about the firm.

A performance indicating parameter, the prediction of which depends on the predicted values of the price and marketing oriented costs in a manner that is specific to the firm and relates to a specific market and a competitive environment in which the firm performs (such as the sales of the firm), will be herein referred to as a “performance indicating parameter which is complexly dependent on the price and marketing oriented costs” or, in short, “a complexly dependent performance indicating parameter”.

There is always a hope to develop a simple analysis method that will be efficient for the handling of a complex reality. In the case of business analysis one can try to develop an analysis that eliminates at least part of the research required to establish the influence of each individual marketing oriented cost of the firm's sales and other complexly dependent performance indicating parameters.

A type of a method of business analysis that handles a number of parameters from the 4Ps list is known as a “multi-attribute attitude method” and particularly, as a method known as a “conjoint analysis method” (Appendix A and “ON FIRMS THAT MAXIMIZE THE EFFICIENCY OF THEIR MARKETING INSTRUMENTS AND THE KAHENMAN-TVERSKY CONSUMER” attached herebelow as Appendix B). This method measures a “value” function of a number of characteristics of the product and the “value” of the product is an aggregate of the values of its characteristics. The analysis of the “value” of a product is used to improve the product and formulate the firm's strategy. It further helps to predict the sales of the product. The value of the product can therefore be a performance indicating parameter.

However the group of variables from the 4Ps list that is handled by multi-attribute attitude models is far from covering the complete 4Ps list. Consequently, the accuracy of multi-attribute attitude models is always questionable (see Appendices A and B).

A second reason for the limited accuracy of existing business analysis methods is that their outcome is influenced by the phenomenon of switching between price and marketing oriented costs (or between different marketing oriented costs) in a way that maintains the performance of the firm but makes a significant difference in the financial reports. For convenience, this phenomenon will be called “switching”.

For example, considering a firm that sells a million products per year for a price of ten dollars each, such that the total revenue is ten million dollars. Let the advertising costs of the firm be 1.5 million dollars and the profit be one million dollars or 10% of the revenue. The firm can decrease the price of a product to nine dollars and at the same time reduce advertising costs by one million dollars. Naturally the first action is expected to increase the number of products sold by the firm, while the second action is expected to decrease the number of products sold by the firm. In the event that the number of sold items, after implementing both actions does not change, meaning that their influences cancel each other out, the profit will not change either. The revenue will nevertheless decrease by 10% and the profit ratio will increase by 11.1%. For a profit maximizing firm this example represents a case in which there exist a significant change in the financial reports, while the actual performance of the firm is very much the same.

Obviously, a firm always seeks for an optimal mixture of price and marketing oriented costs that will optimise its performance. However, Appendix A points out, that once a firm attained such optimal mixture, it can perform small, but significant switching between price and marketing oriented costs (or switching among marketing oriented costs) with minimal influence on its performance. Since firms are often indifferent to changes that maintain its performance, switching can occur for very small reasons and can sometimes be regarded as an almost random phenomenon. The switching, however, usually destroys the accuracy of existing business analysis methods that predict sales involving price and marketing oriented costs.

### DISCLOSURE OF THE INVENTION

It is thus a broad object of the present invention to ameliorate the disadvantages of the known business analysis methods and to provide a new type of simplified business analysis methods.

Methods of this type bring into account the real influence of changes in the price and marketing oriented costs of a product on firm's performance, but does not require the knowledge of the individual influence of each of the marketing oriented costs on the firm's sales and other performance indicating parameters. Furthermore, the value of at least some of the performance indicating parameter generated by methods according to the invention that depend on the price and marketing oriented costs, is not influenced by the switching effect. Such performance indicating parameter can be represented as dependent on one variable instead of the large group of variables that contain price and the marketing oriented costs and its prediction becomes much simpler.

In accordance with the present invention there is therefore provided a method of business analysis for determining a plurality of parameters that indicate the performance of at least one firm selling at least one product, said method comprising processing data including a price of said product and at least one marketing oriented cost to sell said product by said firm, for generating said plurality of parameters, the value of which indicates the performance of said firm relating to production and sales of said product, such that at least one of said parameters is complexly dependent on the price and marketing oriented cost, and establishing a leading variable that depends on said price and marketing oriented cost such that if a) any set of changes in said price and marketing oriented cost involved in the analysis maintains said leading variable unchanged, the value of said complexly dependent performance indicating parameter remains unchanged, and b) sets of changes in said price and marketing oriented cost involved in the analysis change said leading variable, the value of said complexly dependent performance indicating parameter, also changes.

The invention will now be described in connection with certain preferred embodiments, so that it may be more fully understood.

### DESCRIPTION OF THE INVENTION

The present invention is a method of business analysis that obeys the following procedures:

1) The method processes data including data concerning a price, at least one marketing oriented cost and possibly one or more production (manufacturing) costs related to a firm manufacturing (or purchasing) and selling of the product;

2) The method generates a number of parameters, the value of which indicates the performance of the firm regarding the production (or purchasing) and sales of the product; and

3) The method establishes a single variable called “a leading variable” that depends on the price of a product and marketing oriented costs of the firm selling the product, such that at least one of the performance indicating parameters obeys the following conditions: a) it is complexly dependent on the price and marketing oriented costs, b) a set of changes in the price, marketing oriented costs and production costs of a product that maintains the value of the leading variable unchanged does not influence the value of this complexly dependent performance indicating parameter and c) some sets of changes in the price, marketing oriented costs and production costs of a product that changes the value of the leading variable also change the value of this complexly dependent performance indicating parameter.

Mathematically, this is usually done by defining the value of said performance indicating parameter by an algorithm, a formula or a chart in which the value of the complexly dependent performance indicating parameter depends on the leading variable rather than on the individual values of price and the marketing oriented costs. The performance indicating parameter which is dependent on a single variable rather than on a large group of variables, simplifies the method. Appendix A shows that one performance indicating parameter, the prediction of which can be simplified in this way, is the number of products sold by the firm.

Appendix A points out a specific leading variable, the usage of which ensures a reliable prediction of a firm's performance. This variable is called the “firm's mixed price” and in short, the “mixed price”. The mixed price is based on the price and a group of marketing oriented costs of a firm and is described in detail in Appendix A. Specifically the mixed price obeys the condition that once a firm chooses an optimal mixture of price and marketing oriented costs, a series of small, but significant, changes in price and marketing oriented costs that maintains the mixed price does not generate a significant change in the number of units sold by the firm.

The mixed price further obeys the condition that a series of small, but significant, changes in price and the marketing oriented costs that generate a significant change of the mixed price can generate a significant change in the number of products sold by the firm.

In Appendix A it is shown that there always exists a parameter that complies with these conditions and can serve as the mixed price, however, the mixed price is sometimes difficult for direct measurement. Instead, Appendix A proposes the measurement of other parameters and a number of formulas that transfer these measurements into an approximation of a mixed price.

In Appendix A the marketing oriented costs are separated into two subgroups: costs per product (such as the cost of the packaging) denoted cₙ and aggregate costs (such as advertisement) denoted Cₘ. The price is denoted P, the quantity of sold products Q and the mixed price P′.

A number of approximations of the mixed price are as follows:

a) One formula for the approximation of the mixed price requires the measurement of the price P, the marketing oriented costs cₙ and Cₘ. It further required the measurement of the loss of profit, denoted d₀, that the firm, the owners, or the analyser, is ready to suffer in order to gain one dollar of total income while the number of sold products is unchanged. Once these parameters are known, the analyser sets two groups of constants c″ₙ and C″ₘ that serve as reference values for the marketing oriented costs and in fact, it is sufficient to set two aggregate scalars Σₙc″ₙ and ΣₘC″ₘ. The mixed price of a firm P′ is approximated by the expression: P′=P−[Σₙ(cₙ−c″ₙ)+Σₘ(Cₘ−C″ₘ)/Q]/(1+d₀). The constants c″ₙ and C″ₘ will usually determine a set of meaningful levels of the marketing oriented costs, such as the costs during a specific period of time, costs that are expected by the firm, the consumers or the analysers, and

b) A less accurate formula does not require the parameter do and the mixed price is approximated by the expression: P′=P−Σₙ(cₙ−c″ₙ)+Σₘ(Cₘ−C″ₘ)/Q.

The mixed price, or approximations a) or b) can replace the price in existing methods and models (or algorithms) of sale prediction that originally ignore the influence of some of marketing oriented costs. Once the mixed price replaces price in the model (or algorithm), the new model is improved and encompasses the influence of the previously neglected marketing oriented costs (see Appendix A).

The mixed price is not only useful as a leading variable, but also as a performance indicating parameter.

The mixed price is further useful for a better representation of those ratio parameters that involve the total income of a firm. The total income (revenue) defined as the product P*Q, where P is the price and Q the number of sold items, can be replaced by another parameter, referred to as a “mixed revenue”, which equals the product P′*Q where P′ is the mixed price. This representation prevents the influence of the switching effect and encompasses the influence of changes in marketing oriented costs and is therefore more accurate than that which implies the common parameter of revenue. This mixed revenue is also useful as a performance indicating parameter.

The mixed price is further useful for the improvement of multi-attribute attitude methods such that they are expanded to include marketing oriented parameters that were not originally included in the method and specifically promotion parameters from the 4Ps list. This can be done in the following way:

Let mⱼ represent a group of J parameters of the product other than price and let a multi-attribute attitude method define the value functions v(mⱼ) and value function v(P) where P is the price. Let V(m₁ . . . mⱼ,P) be the aggregate value of the product. Let Pr′ be a restricted version of the mixed price that is based on price and a group of marketing oriented costs that does not contain the costs of the parameters investigated by the multi-attribute attitude method. The “mixed value” is then defined as:

V′(m₁ . . . mⱼ,Pr′)=V(m₁ . . . mⱼ, Pr′)

where, Pr′ is the restricted mixed price.

In particular, in the case that V(m₁ . . . mⱼ,P) =Σⱼv(m)+v(P) the mixed value is defined as:

V′(m₁ . . . mⱼ,Pr′)=V(m₁ . . . mⱼ,P)−v(P)+v(Pr′).

The mixed value is also a performance indicating parameter.

In addition the mixed price method can incorporate the following methods:

1) A method that predicts the outputs in an industry and makes use of the concept of “firm's position”, which is per-se well known in marketing theory and discussed in Appendix A. The method starts with the identification of two groups of parameters that are relevant for the representation of the specific industry. The first group is called “strategic variables” and includes all the parameters required for the analysis of the strategic options of the firms and its strategic threats. The second group contains all parameters that influence the sales but are not required for strategic analysis. As long as firms maintain their positions the outputs of the firms mainly depend on the mixed prices. The method contains an algorithm that predicts the output for every combination of mixed prices and another algorithm that supplies the prediction of the levels of the mixed prices. Together the two algorithms predict the outputs in the industry.

2) Same method as in 1) where the firms can change the positions but maintain their strategy.

3) In the case that firms change their strategy, the output of the firm mainly depend on the mixed prices and the strategic variables of all firms. The method contains an algorithm that predicts the outputs for every combination of mixed prices and the levels of the strategic parameters of the firms. The method further contains an algorithm that supplies the prediction of the levels of the mixed prices and the strategic parameters of all firms. Together the two algorithms predict the outputs in the industry.

4) Another method uses an algorithm that treats consumer's purchasing from a firm k as a multiplication of three components. The first component is the frequency that consumer purchases from the industry, the second component is the probability that consumer chooses product k and the third component is the quantity he will purchase from product k once it is chosen. All three components depend on the mixed price and other variables. The method supplies algorithms that predict each component separately and as a result obtains a prediction of the output.

5) Another method is the same as 1) to 4) with an additional algorithm that defines for each product a measurable parameter that only depends on the characteristics of a product, herein called the “attraction” of a product. The probability that a product will be chosen by a consumer is proportional to the attraction of the product (see Appendix B). In particular the probability that a product will be chosen by a consumer can be the attraction of the product divided by the sum of attractions of available products in the industry.

6) Another method is the same as 5) but wherein the “attraction” is not directly measurable, and instead, for an industry with k competitors the method measures the wealth w (or budget b as explained in Appendices A and B and, the patterns of consumers movements among the firms (Appendix B), and uses these measurements to process the attraction of the products (Appendix B).

7) Still another method is same as in 5) where the results of the measurements of the patterns of consumer behaviour is processed to reveal, for each product, three parameters Aₖ, μₖ, and μₖ, for example, those whose nature and approximations techniques are described in Appendix B. The algorithm substantially approximates the attraction of firm k, ATₖ by the expression:

ATₖ≈Aₖ*(1+Pₖ*P′ₖ/w)^{λ}^{ₖ}

or

ATₖ≈Aₖ*(1+Pₖ*Pₖ/b)^{λ}^{ₖ}

where, P′ is the mixed price and

w or b characterize the behavior of the consumer (in particular, w the wealth of the consumer and b the budget of the consumer).

8) Another method is the same as 6), where the results of the measurements of the patterns of consumer movements is processed to reveal for each product it two parameters Aₖ and ρₖ, whose nature and approximation are described in Appendix B. The attraction of firm k, ATₖ, is approximated by the expression:

ATₖ≈Aₖ*exp(ρₖ*P′ₖ/w)

or

ATₖ≈Aₖ*exp(ρₖ*P′ₖ/b)

9) Another method is the same as in 5), where the results of the measurements of the patterns of consumer behaviour is processed to reveal for each product its two parameters Aₖ and λₖ, for example, those whose nature and approximation are described in Appendix B. The attraction of firm k, ATₖ, is substantially approximated by the algorithm:

ATₖ≈Aₖ*(P′ₖ/w)^{λ}^{ₖ}

or

ATₖ≈Aₖ*(P′ₖ/b)^{λ}^{ₖ}

10) The same as 5) to 9) and where the method defines k functions Dₖ(y₁ . . . y_{L}) where y₁ . . . y_{L} are the strategic parameters and measures them for each product and the attraction is approximated by the expression:

ATₖ≈Aₖ₀* Dₖ(y₁ . . . y_{L}) where Aₖ₀ is a constant related to firm k.

All complexly dependent performance indicating parameters and leading variables mentioned above are independent of the production costs of the firm.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of business analysis for determining a plurality of parameters that indicate the performance of at least one firm selling at least one product, said method comprising:
processing data including a price of said product and at least one marketing oriented cost to sell said product by said firm, for generating said plurality of parameters, the value of which indicates the performance of said firm relating to production and sales of said product, such that at least one of said parameters is complexly dependent on the price and marketing oriented cost, and
establishing a leading variable that depends on said price and marketing oriented cost such that if
a) any set of changes in said price and marketing oriented cost involved in the analysis maintains said leading variable unchanged, the value of said complexly dependent performance indicating parameter remains unchanged, and
b) sets of changes in said price and marketing oriented cost involved in the analysis change said leading variable, the value of said complexly dependent performance indicating parameter, also changes.

2. The method as claimed in claim 1, wherein said data includes at least one production cost and said complexly dependent performance indicating parameter and said leading variable, are independent of the production cost of the firm.

3. The method as claimed in claim 1, further comprising an algorithm, a formula or a chart representing said complexly dependent performance indicating parameters as dependent on said leading variable and independent of said price and marketing oriented cost.

4. The method as claimed in claim 1, wherein one said complexly dependent performance indicating parameter processed by the method is a prediction of the number of said products that will be sold by said firm.

5. The method as claimed in claim 1, wherein one of said performance indicating parameters processed by the method, is a mixed revenue.

6. The method as claimed in claim 1, wherein one of said performance indicating parameters processed by the method, is a mixed price.

7. The method as claimed in claim 1, wherein said leading variable is a mixed price.

8. The method as claimed in claim 1, wherein one of said performance indicating parameters is a mixed value defined by a multi-attribute attitude method and the leading variable is a restricted version of the mixed price independent of the marketing oriented cost investigated by said multi-attribute attitude method.

9. The method as claimed in claim 1, wherein said leading variable is substantially approximated by the expression:
P′=P−Σₙ(cₙ−c′ₙ)+Σₘ(Cₘ−C″ₘ)/Q
wherein,
P is the price of the product,
Q is the number of sold products,
cₙ are the measured or predicted values of product marketing oriented costs, and
Cₘ are the measured or predicted values of aggregate marketing oriented costs, and
c″ₙ and C″ₘ are reference values for cₙ and Cₘ.
Aₖ, pₖ are parameters related to firm k in the industry.
P′ₖ is the mixed price of product k, and

10. The method as claimed in claim 1, wherein said leading variable is substantially approximated by the expression:
P′=P−[Σₙ(cₙ−c″ₙ)+Σₘ(Cₘ−C″ₘ)/Q]/(1+d₀)
wherein,
P is the price of the product,
Q is the number of sold products,
cₙ are measured or predicted values of product marketing oriented costs,
Cₘ are measured or predicted values of aggregate marketing oriented costs
c″ₙ and C″ₘ are reference values for cₙ and Cₘ and
d₀ is a loss that the firm is ready to suffer in order to gain 1$ of total income
while the number of sold products remains unchanged.

11. The method as claimed in claim 1, wherein said mixed price value further comprises establishing an attraction value for said product.

12. The method as claimed in claim 11, wherein the method provides a prediction of the probability that, in a competitive industry, a consumer will choose a firm's product and where this probability is proportional to said attraction value.

13. The method as claimed in claim 11, wherein said attraction of a product is substantially approximated by the expression:
ATₖ≈Aₖ*(1+μₖ*P′ₖ/w)^{λ}^{ₖ}
wherein,
ATₖ is the attraction of product k
P′ₖ is the mixed price of the product k,
w is the wealth of the consumer, and
Aₖ, μₖ, and λₖ are parameters related to firm k in the industry.

14. The method as claimed in claim 11, wherein said attraction of a product is substantially approximated by the expression:
ATₖ≈Aₖ*(1+μₖ*P′ₖ/b)^{λ}^{ₖ}
wherein,
ATₖ is the attraction of product k
P′ₖ is the mixed price of the product k,
b is the budget of a customer, and
Aₖ, μₖ, and λₖ, parameters related to firm k in the industry.

15. The method as claimed in claim 11, wherein said attraction of a product is substantially approximated by the expression:
ATₖ≈Aₖ*exp(ρₖ*P′ₖ/w).
wherein,
ATₖ is the attraction of product k
Aₖ and ρₖ are parameters related to firm k in the industry.
P′ₖ is the mixed price of the product k, and
w is the wealth of a customer.

16. The method as claimed in claim 11, wherein said attraction of a product is substantially approximated by the expression:
ATₖ≈Aₖ*(P′ₖ/w)^{λ}^{ₖ}.
wherein,
ATₖ is the attraction of product k
Aₖ and Aₖ are parameters related to firm k in the industry.
P′ₖ is the mixed price of product k,
w is the wealth of the consumer

17. The method as claimed in claim 11, wherein said attraction of a product is substantially approximated by the expression:
ATₖ≈Aₖ*exp(ρₖ*P′ₖ/b)
wherein,
ATₖ is the attraction of product k
Aₖ, ρₖ are parameters related to firm k in the industry.
P′ₖ is the mixed price of product k, and
b is a prediction of the budget of a customer.
